(19) United States
(12) Patent Application Publication
(10) Pub. No.: US 2023/0333581 A1
(43) Pub. Date: Oct. 19, 2023

(54) INTEGRATED TEMPERATURE THRESHOLD DETECTION CIRCUIT AND CORRESPONDING METHOD

(71) Applicant: STMicroelectronics (ALps) SAS, Grenoble (FR)

(72) Inventor: Vratislav Michal, Fontanil-Cornillon (FR)

(21) Appl. No.: 18/296,068

(22) Filed: Apr. 5, 2023

(30) Foreign Application Priority Data
Apr. 14, 2022 (FR) 2203444

(51) Int. Cl. G05F 1/46; G05F 1/567

(52) U.S. Cl. CPC G05F 1/567; G05F 1/468

(57) ABSTRACT

An integrated circuit includes a temperature-independent voltage generating circuit configured to generate a bandgap voltage by summing a voltage proportional to absolute temperature and a voltage complementary to absolute temperature, a temperature threshold detection circuit including a resistive voltage divider bridge configured to generate a reference voltage equal to a fraction of the bandgap voltage and a comparator circuit configured to compare the voltage proportional to absolute temperature with the reference voltage.

### CROSS-REFERENCE TO RELATED APPLICATIONS

This application claims the benefit of French Pat. Application No. 2203444, filed on Apr. 14, 2022, which application is hereby incorporated herein by reference.

### TECHNICAL FIELD

The embodiments and implementations of the invention relate to integrated circuits, in particular temperature threshold detection circuits and methods.

### BACKGROUND

The behavior of an electronic device is generally influenced by temperature. It is recognized, for example, that a laser operating at a low temperature is capable of emitting a more powerful beam. However, when the temperature is too low, this beam can pose a risk for a person exposed thereto. It is thus important to guard against this risk, particularly in order to comply with requirements set by standards, and lowering the emission power can be disadvantageous at hotter temperatures. Conventional techniques for detecting a temperature threshold from which a malfunction of a device such as a laser can occur present difficulties either in terms of a lack of detection accuracy or in terms of product complexity and cost.

More specifically, known circuits for detecting this temperature threshold are not always reliable and do not guarantee accurate detection of the temperature threshold. This is particularly the case when these circuits generate a signal representative of the temperature that can have imperfections.

More specifically, a signal representative of the temperature obtained from such circuits can be subject to undesirable variations. These variations can have different origins, such as variations in the power supply to these circuits. At a given temperature, a variation in the signal representative of the temperature can result, for example, in an offset or a drift in the signal generated to be representative of the temperature, relative to the actual temperature.

As a result, an offset occurring at the detection threshold can result in a significant loss of accuracy in the temperature measurement and either no detection or incorrect detection of the temperature threshold. Although there are ways to reduce the drift of the generated signal, these typically require the addition of complex and expensive circuitry.

There is thus a need to provide a simple solution to improve the reliability of temperature threshold detections with low complexity and at a low cost.

### SUMMARY

According to one aspect, the invention proposes an integrated circuit comprising a temperature-independent voltage generating circuit configured to generate a bandgap voltage by summing a voltage proportional to absolute temperature and a voltage complementary to absolute temperature.

The integrated circuit further comprises a temperature threshold detection circuit including a resistive voltage divider bridge configured to generate a reference voltage equal to a fraction of the bandgap voltage and a comparator circuit configured to compare the voltage proportional to absolute temperature with the reference voltage.

On the one hand, since the reference voltage is obtained from the bandgap voltage, the reference voltage withstands, at least in part, any undesirable variations in the bandgap voltage. On the other hand, the voltage proportional to absolute temperature also withstands, at least in part, any undesirable variations in the bandgap voltage. As a result, any undesirable variations contained in the reference voltage and in the voltage proportional to absolute temperature “intrinsically”, by design, compensate for one another in the comparison. Thus, an accurate and reliable detection is achieved with a temperature-independent voltage generating circuit that can have a conventional, simple and cost-effective design.

According to one embodiment, the temperature-independent voltage generating circuit is configured to generate a bandgap voltage at a base node and wherein the resistive voltage divider bridge includes a first resistive element coupled between the base node and a reference node and a second resistive element coupled between the reference node and a ground terminal.

According to one embodiment, the resistive voltage divider bridge is capable of changing the ratio of the resistive values of the resistive elements while maintaining a total resistive value of the resistive elements in series, in a manner commanded by a control signal.

The ratio of the resistive values of the resistive elements procures the desired reference voltage, i.e. the voltage corresponding to a temperature threshold that is adapted to a given application of the integrated circuit.

According to one embodiment, the temperature-independent voltage generating circuit comprises a first bipolar transistor having a base coupled to the base node, an emitter coupled to an intermediate node of a resistive circuit for adjusting the constant voltage, and a collector coupled to a first leg.

The temperature-independent voltage generating circuit further comprises a second bipolar transistor having a base coupled to the base node, an emitter coupled to the intermediate node of the resistive circuit for adjusting the constant voltage, and a collector coupled to a second leg.

The temperature-independent voltage generating circuit further comprises a current generating circuit configured to generate a first current in the first leg and a second current in the second leg, the first bipolar transistor, the second bipolar transistor, and the resistive circuit for adjusting the constant voltage being jointly configured to generate the voltage proportional to absolute temperature between the intermediate node and the ground terminal, and to generate the voltage complementary to absolute temperature between the base node and the intermediate node.

Such a temperature-independent voltage generating circuit, usually referred to as a “bandgap structure”, enables all of the voltages useful for temperature threshold detection to be produced, in particular the voltage proportional to absolute temperature and the bandgap voltage from which the reference voltage is obtained.

According to one embodiment, the current generating circuit comprises an amplifier having a first input coupled to the first leg and a second input coupled to the second leg, the amplifier being configured to generate a command signal at the base node adapted to command a servo-control of the intensity of the currents flowing in the first leg and in the second leg, via the first bipolar transistor and the second bipolar transistor.

“Servo control of the intensity of the currents” is understood to mean that the command signal generated at the bases of two bipolar transistors with different surface areas is used to simultaneously adjust the conductivity in the two respective legs as a function of the difference in intensity of the currents in these legs. More specifically, for example, for the same base-emitter voltage of the bipolar transistors, the bipolar transistor with the larger surface area is able to increase the intensity of the current flowing in the leg thereof more than the other bipolar transistor, until an identical current is obtained in both legs.

According to one embodiment, the current generating circuit comprises a current mirror arrangement configured to generate the first current in the first leg and the second current in the second leg.

A conventional current mirror arrangement, known per se, allows the current flowing in the first leg to be duplicated to generate a current of the same intensity in the second leg.

According to one embodiment, the current generating circuit comprises a first MOS transistor having conducting terminals coupled on the first leg between the current mirror and the collector of the first bipolar transistor and a command terminal coupled to a node of the second leg, and a second MOS transistor having conducting terminals coupled on the second leg between the node of the second leg and the collector of the second bipolar transistor and a command terminal coupled to the node of the second leg.

The current generating circuit further comprises a third MOS transistor having conducting terminals coupled to a supply voltage terminal and to the base node respectively, and a command terminal coupled to the node of the second leg.

On the one hand, the first MOS transistor reduces the influence of supply voltage variations on the bandgap voltage, and thus on the reference voltage.

On the other hand, the second MOS transistor reduces the influence of the Early effect related to the operation of the bipolar transistors on the current of the second leg. The current of the second leg thus becomes independent of the collector-emitter voltage of the second bipolar transistor. Similarly, it also allows the duplicated current in the first leg to become independent of the collector-emitter voltage of the first bipolar transistor.

Finally, the third MOS transistor provides enough current at the base node to power the resistive voltage divider bridge. Furthermore, the third MOS transistor allows the current in the legs to be servo-controlled upon a command at the bases of the bipolar transistors in a manner similar to the command signal defined hereinabove.

Another aspect provides for a system comprising the integrated circuit as defined hereinabove, wherein the comparator circuit is configured to generate a detection signal when the voltage proportional to absolute temperature is lower than the reference voltage, or when the voltage proportional to absolute temperature is higher than the reference voltage, and a control circuit connected to the temperature threshold detection circuit and to an element having temperature-dependent characteristics, the control circuit being configured to deactivate the element when the detection signal is generated.

Systems exist that incorporate elements that can have temperature-dependent characteristics that can pose a risk when exposed to excessively high or low temperatures. Thus, by using a temperature threshold detection circuit as defined hereinabove within these systems, these devices can be deactivated in an autonomous and automatic manner in order to effectively protect the user from these risks.

According to another aspect, the invention proposes a method for detecting a temperature threshold from a bandgap voltage generated by summing a voltage proportional to absolute temperature and a voltage complementary to absolute temperature, comprising generating a reference voltage equal to a fraction of the bandgap voltage, and comparing the voltage proportional to absolute temperature with the reference voltage.

According to one implementation, the generation of the bandgap voltage is carried out at a base node and wherein the generation of the reference voltage equal to a fraction of the bandgap voltage is carried out with a resistive voltage divider bridge including a first resistive element coupled between the base node and a reference node and a second resistive element coupled between the reference node and a ground terminal.

According to one implementation, the method comprises changing, via the voltage divider bridge, the ratio of the resistive values of the resistive elements while maintaining a total resistive value of the resistive elements in series, in a manner commanded by a control signal.

According to one implementation, the generation of the bandgap voltage comprises generating a first current in a first leg coupled to the collector of a first bipolar transistor, and a second current in a second leg coupled to the collector of a second bipolar transistor, and generating the voltage proportional to absolute temperature at the terminals of a first resistive element coupled between an emitter of the first bipolar transistor and a ground terminal.

The generation of the bandgap voltage further comprises generating the voltage complementary to absolute temperature between a base of the second bipolar transistor and an intermediate node coupled to the emitter of the second bipolar transistor via a second resistive element.

According to one implementation, the generation of the first current in the first leg and of the second current in the second leg comprises commanding the first bipolar transistor and the second bipolar transistor, so as to reduce the intensity difference between the currents flowing in the first leg and in the second leg respectively, as a function of the difference between the intensity of the first current flowing in the first leg and the intensity of the second current flowing in the second leg.

According to one implementation, the generation of the first current in the first leg and of the second current in the second leg is carried out by a current mirror arrangement.

According to another aspect, the invention provides for a method comprising the method for detecting a temperature threshold as defined hereinabove, comprising generating a detection signal, via the comparator circuit, when the voltage proportional to absolute temperature is lower than the reference voltage, or when the voltage proportional to absolute temperature is higher than the reference voltage, and deactivating an element having temperature-dependent characteristics, via a control circuit connected to the threshold detection circuit when the detection signal is generated.

### BRIEF DESCRIPTION OF THE DRAWINGS

Other advantages and features of the invention will become apparent upon examining the detailed description of non-limiting embodiments and implementations, and from the accompanying drawings in which:

FIG. 1 diagrammatically shows an integrated circuit including a temperature-independent voltage generator BG according to one embodiment;

FIG. 2 shows an alternative embodiment of the current generating circuit comprising an active current mirror arrangement; and

FIG. 3 shows a system comprising the integrated circuit as described with respect to FIGS. 1 or 2.

### DETAILED DESCRIPTION OF ILLUSTRATIVE EMBODIMENTS

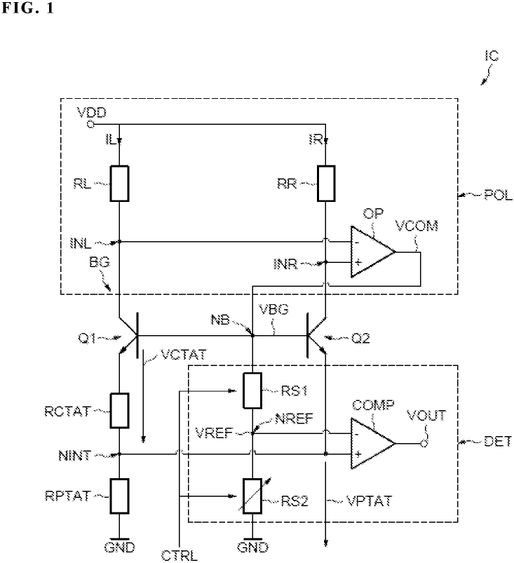

FIG. 1 diagrammatically shows an integrated circuit IC including a temperature-independent voltage generator BG according to one embodiment.

The temperature-independent voltage generating circuit BG includes a first bipolar transistor Q1 and a second bipolar transistor Q2. Such bipolar transistors used in a temperature-independent voltage generating circuit BG are known per se and have different emitter regions and different current densities at the base-emitter junction. By way of example, the surface area of the first bipolar transistor Q1, corresponding to the size of the first bipolar transistor Q1, can be eight times greater than the surface area of the second bipolar transistor Q2. In order to achieve such a size ratio, the first bipolar transistor Q1 can comprise a parallel connection of N bipolar transistors, for example N=8, wherein each of the bipolar transistors has a surface area that is identical to that of the second bipolar transistor Q2. Such a parallel connection can be made by respectively coupling the collectors, emitters and bases of each transistor together. A surface area that is N times greater allows the bipolar transistor to amplify the intensity of the current on its collector by a factor of N for the same voltage applied between its base and its emitter.

The base of the first bipolar transistor Q1 and the base of the second bipolar transistor Q2 are connected to one another at a common base node NB. In particular, the first bipolar transistor Q1 has a collector connected to a first leg. The second bipolar transistor Q2 has a collector connected to a second leg.

The first bipolar transistor Q1 includes an emitter coupled to an intermediate node NINT of a resistive circuit for adjusting the constant voltage, via a first resistor RCTAT. The second bipolar transistor Q2 includes an emitter coupled to the intermediate node NINT of the resistive circuit for adjusting the constant voltage. The resistive circuit for adjusting the constant voltage includes the first resistor RCTAT connected between the emitter of the first bipolar transistor Q1 and the intermediate node NINT and a second resistor RPTAT connected between the intermediate node NINT and a ground terminal GND.

The first bipolar transistor Q1, the second bipolar transistor Q2 and the resistive circuit for adjusting the constant voltage are jointly configured to generate a voltage proportional to absolute temperature VPTAT between the intermediate node NINT and the ground terminal GND, and to generate a voltage complementary to absolute temperature VCTAT between the base node NB and the intermediate node NINT. In particular, the voltage complementary to absolute temperature VCTAT has a coefficient inversely proportional to the temperature, and the voltage proportional to absolute temperature VPTAT has a coefficient proportional to the temperature, which are derived from the difference in current density at the base-emitter junction between the first bipolar transistor Q1 and the second bipolar transistor Q2 when a current of the same intensity passes through the transistors Q1 and Q2.

Thus, at the base node NB, there is a bandgap voltage VBG equal to the sum of the voltage proportional to absolute temperature VPTAT and the voltage complementary to absolute temperature VCTAT.

Advantageously, the values of the resistors RCTAT and RPTAT are adjusted in order to adjust the voltages VPTAT and VCTAT to obtain the bandgap voltage VBG.

The temperature-independent voltage generating circuit BG further comprises a current generating circuit POL. The current generating circuit POL comprises a supply voltage terminal VDD and an operational amplifier OP.

The amplifier OP has a first input INL connected to the first leg, a second input INR connected to the second leg and an output connected to the base node NB. The first input INL and the second input INR correspond to the inverting input and to the non-inverting input of the amplifier OP respectively.

Furthermore, the current generating circuit POL includes a resistor RL on the first leg and a resistor RR on the second leg.

The resistor RL is connected between the supply voltage terminal VDD and the first input INL of the amplifier OP on the first leg. The resistor RR is connected between the supply voltage terminal VDD and the second input INR of the amplifier OP on the second leg.

The resistors RL and RR have equal resistive values and are used to generate voltage signals at the inputs of the operational amplifier OP, which voltage signals are directly proportional to the currents flowing respectively in the first leg IL and in the second leg IR.

The amplifier OP is configured to generate a command signal VCOM at the base node NB, for example a command voltage, as a function of the difference in potential between the first input INL and the second input INR. This difference in potential is positive when the potential of the first input INL is higher than the potential of the second input INR, and negative if this is not the case.

In particular, the command signal VCOM is used to command the base current of the first bipolar transistor Q1 and of the second bipolar transistor Q2 until the first current IL and the second current IR are identical.

On the one hand, the command signal VCOM is used to command an increase in the base current of the first bipolar transistor Q1 and of the second bipolar transistor Q2 when the difference in potential between the inputs of the amplifier OP is negative.

On the other hand, the command signal VCOM is used to command a decrease in the base current when the difference in potential between the inputs of the amplifier OP is positive.

As a result, the command signal VCOM is adapted to command a servo-control of the intensity of the first current IL flowing in the first leg and of the second current IR flowing in the second leg. The intensities of the currents IL and IR can thus be regulated throughout the entire operating period of the temperature-independent voltage generating circuit BG.

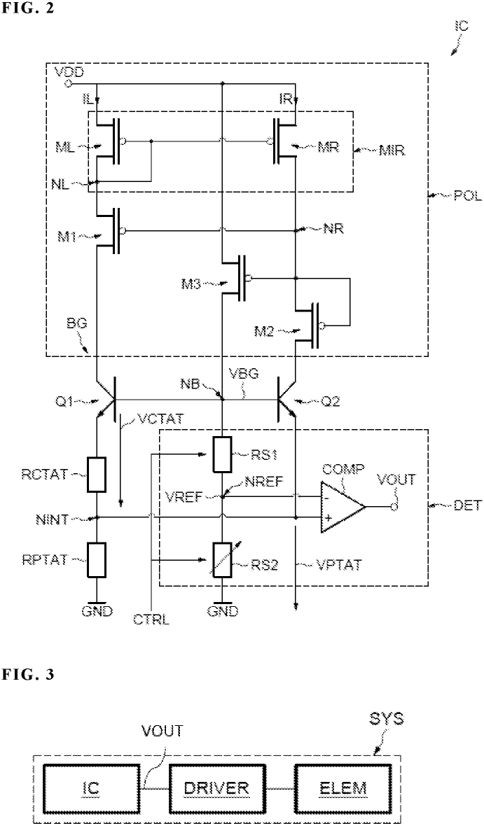

Alternatively, the current generating circuit POL can be implemented with a MOS (acronym of the conventional terms known per se “Metal Oxide Semiconductor”) transistor arrangement as described hereinbelow with reference to FIG. 2.

The integrated circuit IC further comprises a temperature threshold detection circuit DET. The threshold detection circuit DET includes a resistive voltage divider bridge. The resistive voltage divider bridge includes a first resistor RS1 and a second resistor RS2. The first resistor RS1 is connected between the base node NB and a reference node NREF and the second resistor RS2 is connected between the reference node NREF and the ground terminal GND.

Thus, the resistive voltage divider bridge generates a reference voltage VREF between the reference node NREF and the ground terminal GND. The reference voltage VREF is equal to a fraction of the bandgap voltage VBG and is in particular:

$$\frac{R S 2}{R S 1 + R S 2}$$

k × VBG.

Moreover, the resistive voltage divider bridge can receive a control signal CTRL from an external driver circuit for example. Depending on the control signal CTRL received, the resistive voltage divider bridge can increase or decrease the ratio “k” of the resistive values of the first resistor RS1 and of the second resistor RS2 while maintaining a total resistive value of the resistors RS1 and RS2 in series.

A user can thus define the resistive ratio of the resistive voltage divider bridge using the control signal CTRL and consequently change the value of the reference voltage VREF. The reference voltage VREF can be changed to match a desired temperature threshold for a given application, for example at a temperature of -15° C.

The temperature threshold detection circuit DET further includes a comparator circuit COMP which can be an operational amplifier connected as a comparator, for example.

The comparator circuit COMP comprises an inverting input connected to the reference node NREF and a non-inverting input connected to the intermediate node NINT. This allows a drop in temperature to below the temperature threshold determined by the reference voltage VREF to be detected.

By swapping the connections of the inputs of the comparator circuit COMP, i.e. by connecting the inverting input to the intermediate node NINT and the non-inverting input to the reference node NREF, the comparator circuit COMP is configured to detect a temperature rise above the temperature threshold determined by the reference voltage VREF.

After the comparison, the comparator circuit COMP outputs a detection signal VOUT when the voltage proportional to absolute temperature VPTAT is greater than the reference voltage VREF or when the voltage proportional to absolute temperature VPTAT is less than the reference voltage VREF.

Thus, the comparator circuit COMP can detect when the measured temperature reaches a high temperature threshold or a low temperature threshold.

On the one hand, if a spurious variation in the bandgap voltage VBG occurs, then a spurious variation is also found in the voltage complementary to absolute temperature VPTAT and in the voltage proportional to absolute temperature VPTAT which define the bandgap voltage VBG. In other words, the voltage proportional to absolute temperature VPTAT undergoes similar variations to those of the bandgap voltage VBG.

On the other hand, the reference voltage VREF has a spurious variation corresponding to the variation in the voltage VBG in proportion to the resistive ratio “k” of the voltage divider resistive bridge.

By comparing the voltage proportional to absolute temperature VPTAT with the reference voltage VREF, first-order compensation occurs between the spurious variations in each of these voltages.

The compensation of the spurious variations allows the disparity between the signal proportional to temperature VPTAT and the reference voltage VREF to be substantially reduced in order to ensure that the temperature threshold is detected in a reliable manner.

For example, experimental measurements carried out for a detection of a temperature threshold of -15° C. were obtained with an inaccuracy of only 2.7° C. for a maximum deviation from the mean corresponding to three standard deviations.

FIG. 2 shows an alternative embodiment of the current generating circuit POL comprising, in this alternative embodiment, an active current mirror arrangement MIR.

The current mirror arrangement MIR comprises a MOS transistor ML on the first leg and a MOS transistor MR on the second leg. The MOS transistor ML of the first leg has a source connected to the supply voltage terminal VDD, a gate and a drain connected to a node NL of the first leg. The MOS transistor MR of the second leg has a source connected to the supply voltage terminal VDD, a gate coupled to the gate of the MOS transistor ML of the first leg and a drain connected to a node NR of the second leg.

Such a current mirror arrangement MIR conventionally allows for the generation of the first current IL on the first leg and the second current IR, of the same intensity as the first current IL, on the second leg.

The current generating circuit POL further comprises a first MOS transistor M1, a second MOS transistor M2 and a third MOS transistor M3.

The first MOS transistor M1 has a source connected to the drain of the MOS transistor ML of the first leg, a gate connected to the node NR of the second leg and a drain connected to the collector of the first bipolar transistor Q1.

The first MOS transistor M1 reduces the influence of the variations in the supply voltage VDD on the bandgap voltage VBG, and thus on the reference voltage VREF.

The second MOS transistor M2 has a source and a gate connected to the node NR of the second leg and a drain connected to the collector of the second bipolar transistor Q2.

The second MOS transistor M2 reduces the influence of the Early effect related to the operation of the bipolar transistors Q1 and Q2 on the second current IR of the second leg. The current IR of the second leg thus becomes independent of the collector-emitter voltage of the second bipolar transistor Q2. Similarly, it also allows the duplicated first current IL in the first leg to become independent of the collector-emitter voltage of the first bipolar transistor Q1.

The third MOS transistor M3 has a source connected to the supply voltage terminal VDD, a gate connected to the node NR of the second leg and a drain connected to the base node NB.

Finally, the third MOS transistor M3 provides enough current at the base node NB to power the resistive voltage divider bridge. Furthermore, the third MOS transistor M3 allows the current in the legs to be servo-controlled upon a command at the bases of the bipolar transistors Q1 and Q2 in a manner similar to the command signal VCOM defined hereinabove.

FIG. 3 shows a system SYS comprising the integrated circuit IC as described hereinabove with reference to FIG. 1 or with reference to FIG. 2.

The system SYS comprises a control circuit DRIVER and an element ELEM with temperature-dependent characteristics. The control circuit DRIVER is connected to the temperature threshold detection circuit DET and to the element ELEM. The element ELEM can be an electronic device such as a vertical-cavity laser diode that can emit relatively strong radiation when the temperature is below a threshold, for example when the temperature is below -15° C. The control circuit DRIVER can typically be a laser diode driver circuit.

The control circuit DRIVER is configured to deactivate the element ELEM when the detection signal VOUT is generated. Disabling the element ELEM, such as the laser diode, at the temperature threshold can, for example, prevent the diode from emitting radiation that could be hazardous to a user, and/or meet a standard.

What is claimed is:

1. An integrated circuit comprising:
a temperature-independent voltage generating circuit configured to generate a bandgap voltage by summing a voltage proportional to an absolute temperature and a voltage complementary to the absolute temperature;
a temperature threshold detection circuit including a resistive voltage divider bridge configured to generate a reference voltage equal to a fraction of the bandgap voltage; and
a comparator circuit configured to compare the voltage proportional to the absolute temperature with the reference voltage.

2. The integrated circuit according to claim 1, wherein the temperature-independent voltage generating circuit is configured to generate the bandgap voltage at a base node, and wherein the resistive voltage divider bridge includes a first resistive element coupled between the base node and a reference node and a second resistive element coupled between the reference node and a ground terminal.

3. The integrated circuit according to claim 2, wherein the resistive voltage divider bridge is configured to change a ratio of resistive values of the resistive elements while maintaining a total resistive value of the resistive elements in series, in a manner commanded by a control signal.

4. The integrated circuit according to claim 2, wherein the temperature-independent voltage generating circuit comprises:
a first bipolar transistor having a base coupled to the base node, an emitter coupled to an intermediate node of a resistive circuit for adjusting a constant voltage, and a collector coupled to a first leg;
a second bipolar transistor having a base coupled to the base node, an emitter coupled to the intermediate node of the resistive circuit for adjusting the constant voltage, and a collector coupled to a second leg; and
a current generating circuit configured to generate a first current in the first leg and a second current in the second leg;
wherein the first bipolar transistor, the second bipolar transistor, and the resistive circuit for adjusting the constant voltage are jointly configured to:
generate the voltage proportional to the absolute temperature between the intermediate node and the ground terminal; and
generate the voltage complementary to the absolute temperature between the base node and the intermediate node.

5. The integrated circuit according to claim 4, wherein the current generating circuit comprises an amplifier having a first input coupled to the first leg and a second input coupled to the second leg, wherein the amplifier is configured to generate a command signal at the base node adapted to command a servo-control of an intensity of the currents flowing in the first leg and in the second leg, via the first bipolar transistor and the second bipolar transistor.

6. The integrated circuit according to claim 4, wherein the current generating circuit comprises a current mirror arrangement configured to generate the first current in the first leg and the second current in the second leg.

7. The integrated circuit according to claim 6, wherein the current generating circuit comprises:
a first MOS transistor having conducting terminals coupled on the first leg between the current mirror arrangement and the collector of the first bipolar transistor and a command terminal coupled to a node of the second leg; and
a second MOS transistor having conducting terminals coupled on the second leg between the node of the second leg and the collector of the second bipolar transistor and a command terminal coupled to the node of the second leg; and
a third MOS transistor having conducting terminals coupled to a supply voltage terminal and to the base node respectively, and a command terminal coupled to the node of the second leg.

8. A system, comprising:
an integrated circuit comprising:
a temperature-independent voltage generating circuit configured to generate a bandgap voltage by summing a voltage proportional to an absolute temperature and a voltage complementary to the absolute temperature;
a temperature threshold detection circuit including a resistive voltage divider bridge configured to generate a reference voltage equal to a fraction of the bandgap voltage; and
a comparator circuit configured to:
compare the voltage proportional to the absolute temperature with the reference voltage; and
generate a detection signal in response to the voltage proportional to the absolute temperature being lower than the reference voltage, or in response to the voltage proportional to the absolute temperature being higher than the reference voltage; and
a control circuit connected to the temperature threshold detection circuit and to an element having temperature-dependent characteristics, the control circuit being configured to deactivate the element in response to the detection signal being generated.

9. The system according to claim 8, wherein the temperature-independent voltage generating circuit is configured to generate the bandgap voltage at a base node, and wherein the resistive voltage divider bridge includes a first resistive element coupled between the base node and a reference node and a second resistive element coupled between the reference node and a ground terminal.

10. The system according to claim 9, wherein the resistive voltage divider bridge is configured to change a ratio of resistive values of the resistive elements while maintaining a total resistive value of the resistive elements in series, in a manner commanded by a control signal.

11. The system according to claim 9, wherein the temperature-independent voltage generating circuit comprises:
a first bipolar transistor having a base coupled to the base node, an emitter coupled to an intermediate node of a resistive circuit for adjusting a constant voltage, and a collector coupled to a first leg;
a second bipolar transistor having a base coupled to the base node, an emitter coupled to the intermediate node of the resistive circuit for adjusting the constant voltage, and a collector coupled to a second leg; and
a current generating circuit configured to generate a first current in the first leg and a second current in the second leg;
wherein the first bipolar transistor, the second bipolar transistor, and the resistive circuit for adjusting the constant voltage are jointly configured to:
generate the voltage proportional to the absolute temperature between the intermediate node and the ground terminal; and
generate the voltage complementary to the absolute temperature between the base node and the intermediate node.

12. The system according to claim 11, wherein the current generating circuit comprises an amplifier having a first input coupled to the first leg and a second input coupled to the second leg, wherein the amplifier is configured to generate a command signal at the base node adapted to command a servo-control of an intensity of the currents flowing in the first leg and in the second leg, via the first bipolar transistor and the second bipolar transistor.

13. The system according to claim 11, wherein the current generating circuit comprises a current mirror arrangement configured to generate the first current in the first leg and the second current in the second leg.

14. The system according to claim 13, wherein the current generating circuit comprises:
a first MOS transistor having conducting terminals coupled on the first leg between the current mirror arrangement and the collector of the first bipolar transistor and a command terminal coupled to a node of the second leg; and
a second MOS transistor having conducting terminals coupled on the second leg between the node of the second leg and the collector of the second bipolar transistor and a command terminal coupled to the node of the second leg; and
a third MOS transistor having conducting terminals coupled to a supply voltage terminal and to the base node respectively, and a command terminal coupled to the node of the second leg.

15. A method comprising:
summing a voltage proportional to an absolute temperature and a voltage complementary to the absolute temperature to generate a bandgap voltage;
generating a reference voltage equal to a fraction of the bandgap voltage;
comparing the voltage proportional to the absolute temperature with the reference voltage; and
detecting a temperature threshold from the bandgap voltage.

16. The method according to claim 15, further comprising:
performing the generating the bandgap voltage at a base node; and
performing the generating the reference voltage equal to the fraction of the bandgap voltage with a resistive voltage divider bridge including a first resistive element coupled between the base node and a reference node, and a second resistive element coupled between the reference node and a ground terminal.

17. The method according to claim 16, further comprising changing, via the resistive voltage divider bridge, a ratio of resistive values of the resistive elements while maintaining a total resistive value of the resistive elements in series, in a manner commanded by a control signal.

18. The method according to claim 15, wherein the generating the bandgap voltage comprises:
generating a first current in a first leg coupled to a collector of a first bipolar transistor, and a second current in a second leg coupled to a collector of a second bipolar transistor;
generating the voltage proportional to the absolute temperature at terminals of a first resistive element coupled between an emitter of the first bipolar transistor and a ground terminal; and
generating the voltage complementary to the absolute temperature between a base of the second bipolar transistor and an intermediate node coupled to the emitter of the second bipolar transistor via a second resistive element.

19. The method according to claim 18, wherein the generating the first current in the first leg and the second current in the second leg comprises commanding the first bipolar transistor and the second bipolar transistor, so as to reduce an intensity difference between the currents flowing in the first leg and in the second leg respectively, as a function of the intensity difference.

20. The method according to claim 18, wherein the generating the first current in the first leg and the second current in the second leg is performed by a current mirror arrangement.

21. The method according to claim 15, further comprising:
generating a detection signal in response to the voltage proportional to the absolute temperature being lower than the reference voltage, or in response to the voltage proportional to the absolute temperature is higher than the reference voltage; and
deactivating an element having temperature-dependent characteristics, via a control circuit in response to the detection signal being generated.
